(19) United States
(12) Patent Application Publication
(10) Pub. No.: US 2009/0153832 A1
(43) Pub. Date: Jun. 18, 2009

(54) APPARATUS AND METHOD FOR ISOLATING VIBRATIONS IN A LITHOGRAPHY MACHINE USING TWO ACTIVE CONTROL UNITS

(76) Inventors: Yosuke TATSUZAKI, Kumagaya (JP); Ping-Wei CHANG, San Jose, CA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 11/959,005

(22) Filed: Dec. 18, 2007

(51) Int. Cl. G03B 27/32; G01P 15/08; H02N 2/02

(52) U.S. Cl. 355/72; 73/652; 310/328

(57) ABSTRACT

An apparatus and method effectively isolate vibrations in a lithography machine. The apparatus and method include a first control for actively reducing the vibrations in a first frequency range and a second control for actively reducing the vibrations in a second frequency range. The first control further includes a first actuator such as a force actuator and a static reference object with which relatively low-frequency vibrations are reduced. The second control further includes a second actuator such as a Piezo actuator and an air spring in which relatively high-frequency vibrations are reduced. The apparatus and method are applied to substantially prevent the vibrations on the floor from traveling to the mask stage in one embodiment.

### FIELD OF THE INVENTION

The current invention is generally related to vibration isolation techniques in a lithographic imaging system, and more particularly related to the isolating apparatus and method of isolating vibrations based upon at least two active control units during an imaging transforming operation of the lithographic system.

### BACKGROUND OF THE INVENTION

Lithography systems are commonly used to transfer images from a reticle onto a semiconductor wafer during semiconductor manufacturing processing. Lithography apparatuses are also used for manufacturing liquid crystal devices, imaging devices such as CCDs, thin film magnetic heads on a glass plate or the like. In general, a typical lithography projection system includes an optical assembly, a reticle stage for positioning a reticle or a mask defining a predetermined pattern, a wafer stage assembly for positioning a semiconductor wafer or a substrate and a measurement sub-system for monitoring the precise position of the reticle and the wafer.

During operation, the optical assembly projects an image pattern on the mask onto the wafer, and the projected image is exposed on one or more die on the wafer. A single wafer usually contains a plurality of die or fields to be successively irradiated to form multiple semiconductor devices. During each exposure of the so-called “step and scan” process, the mask stage and the wafer stage move in a synchronized manner to transfer the image pattern from the mask to a particular field of the wafer. After each exposure, the wafer stage assembly moves the wafer so as to expose every die of the wafer. Subsequently, the wafer is replaced by a new wafer. In the above described semiconductor manufacturing process, a lithographic apparatus must accurately image the pattern from the mask onto the substrate with typical dimensions in the micron or submicron range.

Accordingly, disturbances or vibrations need to be avoided since they can significantly alter the position of the pattern with respect to the wafer to affect the above required accuracy. The disturbances originate from external sources such as floor vibrations and air pressure waves. In general, the external vibration sources are not directly a part of the lithography apparatus. The disturbances also originate from internal sources within the lithography apparatus such as reaction forces of a positioning device of the substrate holder, the mask holder and other mechanically moving parts. Consequently, it is necessary that the lithographic apparatus is configured to substantially suppress or circum-vent these external and internal vibrations from affecting its precise operation.

As disclosed in U.S. Pat. No. 7,084,956, a lithographic apparatus is supported by a base via supporting devices for preventing the transmission of vibrations from the base to the frame. As shown in FIG. 1, each prior art supporting device 1 is connected to the frame 8 via the upper plate 10 and the base 5 via the lower plate 25. The gas or air spring 30 and the Lorentz force actuator 40 are both positioned between the base 5 and the frame 8. A vibration sensor 45 is located on the upper plate 10 for measuring vibration of the frame 8 to provide a movement signal to control the Lorentz force actuator 40. The position sensor 60 is also located on the upper plate 10 to measure a relative position with respect to the reference object 50, which is supported on the lower plate 20 via the reference support spring 70. The position sensor 60 provides a distance signal to control the Lorentz force actuator 40 to adjust the position of the upper plate 10 with respect to the reference object 50. The reference object-spring system has the resonance frequency around 0.5 Hz, that is lower than the natural frequency of the support system. The reference object 50 has a relatively low mass of 1 kg or less.

In the above prior art technique and many others, the vibrations are isolated based upon a combination of the active control unit and the passive control unit. Although the passive unit can be adjusted depending upon its application prior to its use, the effectiveness for reducing vibrations is not adjusted during operation. Thus, it still remains desirable to improve the isolation of vibrations.

### The Summary of Invention

An apparatus and method effectively isolate vibrations in a lithography machine. The apparatus and method include a first control for actively reducing the vibrations in a first frequency range and a second control for actively reducing the vibrations in a second frequency range. The first control further includes a first actuator and a static reference object with which the vibrations are measured. The second control further includes a second actuator and an air spring in which the vibrations are measured. The apparatus and method are applied to substantially prevent the vibrations on the floor from traveling to the mask stage in one embodiment.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a embodiment of the invention.

### BRIEF DESCRIPTION OF THE DRAWINGS

The invention will be described in conjunction with the following drawings of exemplary embodiments in which like reference numerals designate like elements, and in which:

FIG. 1 is a diagrammatic cross-sectional view of the prior art supporting device for isolating vibrations in U.S. Pat. No. 7,084,956;

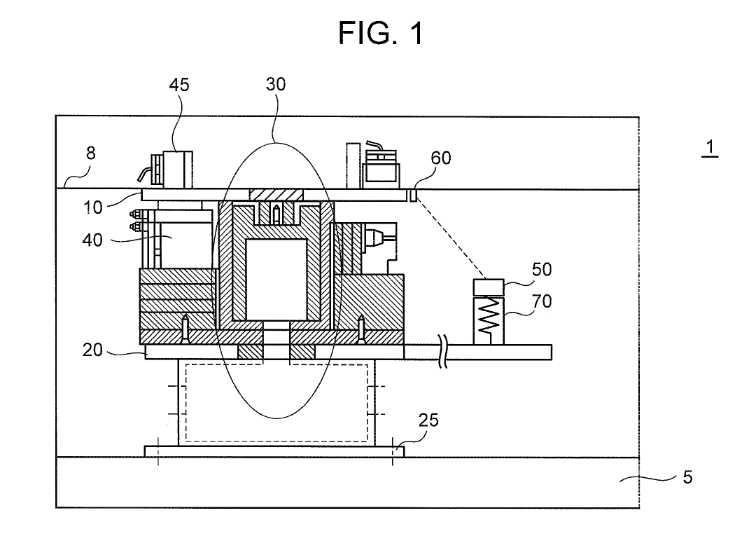

FIG. 2 is a partial side view of the lithography apparatus according to the current invention;

FIG. 3 is a schematic diagram of the major components of one embodiment of the vibration isolation apparatus according to the current invention;

FIG. 4 is a diagram illustrating a first active feed-back control loop as used in the vibration isolation apparatus according to the current invention;

FIG. 5 is a diagram illustrating a second active feed-back control loop as used in the vibration isolation apparatus according to the current invention;

FIG. 6 is a cross-sectional view illustrating another embodiment of the lithography apparatus according to the current invention; and

FIG. 7 is a schematic diagram of the major components of the second embodiment of the vibration isolation apparatus according to the current invention.

### DETAILED DESCRIPTION OF THE EMBODIMENT(S)

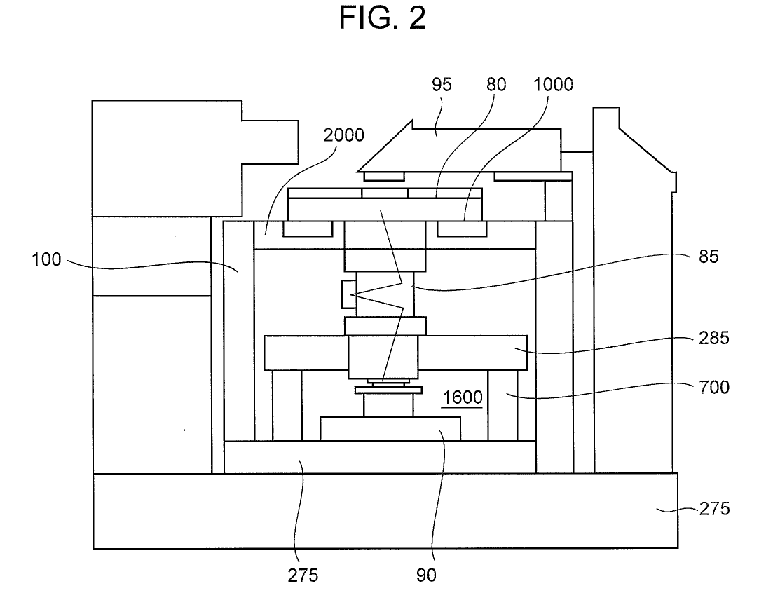

Referring now to the drawings, wherein like reference numerals designate corresponding structures throughout the views, and referring in particular to FIG. 2, a diagram in a partial side view illustrates a embodiment of the lithography apparatus according to the current invention. The lithography apparatus includes a illumination unit 95, a mask stage 80 for holding and positioning a mask or a reticle that defines a predetermined pattern, a wafer stage 90 for holding and positioning a semiconductor wafer or a substrate to be irradiated according to the predetermined pattern, a lens body 85 located between the two stages for housing an optical assembly that forms an image of the predetermined pattern and a frame structure 100 for supporting components such as the mask stage 80. The lithography apparatus is of various types with its light source using ultraviolet (UV), deep ultraviolet (DUV), extreme ultraviolet (EUV), electron beam or other suitable sources. The reference body 285 holds the lens body 85, which includes a cylindrical portion.

Still referring to FIG. 2, the image formation process is substantially free from vibrations. A primary effect is that the mask stage 80 is substantially free from the vibrations externally originated in the areas such as the floor outside the lithography apparatus. Secondarily, the lens body 85 is substantially isolated from vibrations that are internally originated from mechanically moving devices such as the mask stage 80 and the wafer stage 90. To isolate an isolated body 200 from vibrations caused by the mask stage 80, an isolated body subsystem 1000 of the anti-vibration system is located near the mask stage and the isolated body 200 so that the lens body 85 is substantially undisturbed. Similarly, the reference body 285 is isolated from vibrations by a reference body subsystem 1500 of the anti-vibration system that includes reference body isolators 700 located between the reference body 285 and a base 275. This also leads to the stable lens body 85. In general, the reference body subsystem 1500 of the anti-vibration system substantially minimizes the vibrations on the floor while the isolated body subsystem 1000 substantially minimizes the vibrations from the mask stage 80 and at frame 100.

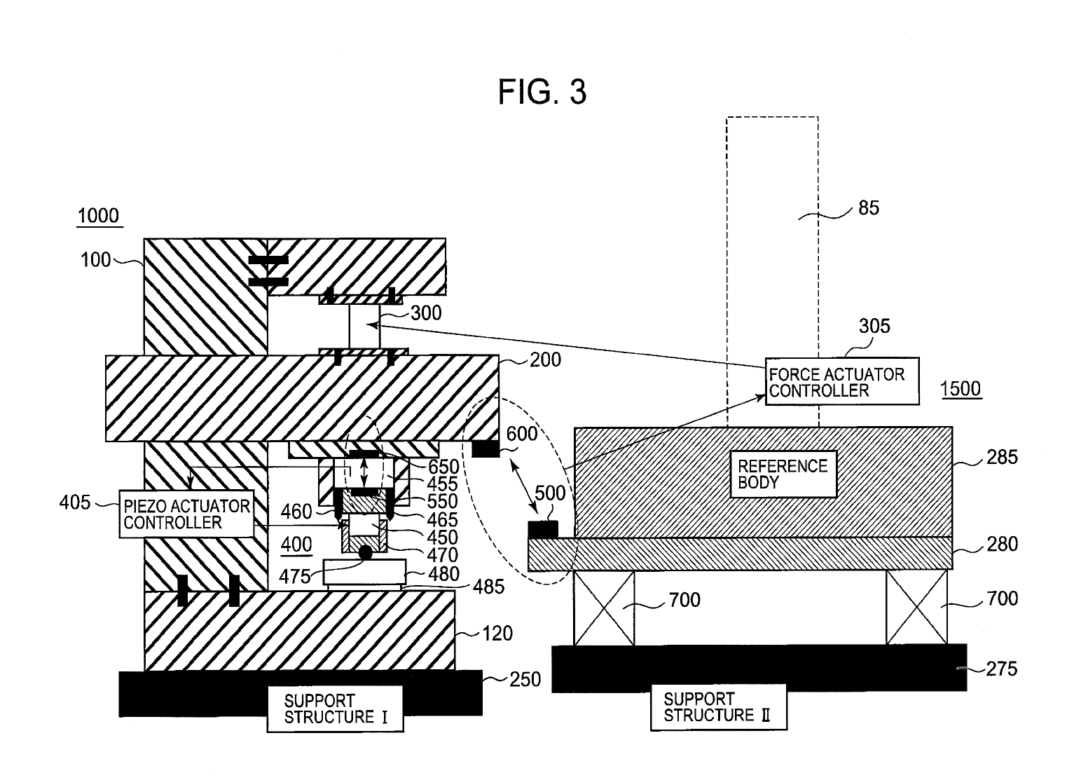

Now referring to FIG. 3, a schematic diagram illustrates the reference body subsystem 1500 and the isolated body subsystem 1000 in the embodiment of the anti-vibration system according to the current invention. Although the two major aspects of the anti-vibration system are illustrated in this schematic diagram, the anti-vibration system is not limited to the illustrated units or components according to the current invention. Furthermore, the physical relationship between the two subsystems 1000, 1500 is also not necessarily limited to the illustrated relative locations in the perspective view of the lithography apparatus in FIG. 2. The diagram of FIG. 3 illustrates that the reference body subsystem 1500 and the isolated body subsystem 1000 are taken outside of the lithography apparatus body and are placed side-by-side.

The reference body subsystem 1500 of the anti-vibration system includes a base support structure or base 275, a plurality of reference body isolators 700, a reference body position sensor 500 and a reference body 285. In general, the base 275 is placed directly over the floor such as concrete and is made of rather rigid material such as cast iron. A plurality of the reference body isolators 700 is placed on the base 275 to mount the reference body 285 at a certain predetermined height from the base 275. Although the diagram illustrates only two reference body isolators 700 due to its side view, a set of three reference isolators 700 is usually used in a embodiment.

The reference body subsystem 1500 provides an extremely static reference object. To effectively maintain the static state, the reference body 285 is a huge mass, weighing approximately six metric tons that is at least one half of the total lithographic apparatus weight. The physical dimension of the reference body 285 is in the order of several feet in width, length and height. The reference body 285 has no moving parts to cause internal vibrations and is substantially isolated from external vibrations by the reference body isolators 700. Since the base 275 is placed directly over the floor and made of rather rigid material such as cast iron, it lacks vibration-attenuating function on the vibrations existing on the floor. Although the reference body 285 is placed over the floor, it is supported by a plurality of the reference body isolators 700 to prevent the transmission of the vibrations from the floor via the base 275.

The reference body isolators 700 isolate the vibrations which are both internally and externally originated. The internally originated vibrations are primarily caused by the reaction force in response to the movement initiated by the wafer stage 90. The externally originated vibrations primarily travel through the base 275 from the floor. In one embodiment, a set of three reference body isolators 700 is kinematically placed on the base 275 to mount the reference body 285 so as not to over-constrain the reference body 285 (only two reference body isolators 700 are shown in FIG. 3). In one embodiment, each of the reference body isolators 700 includes active vibration control elements and passive vibration control elements. The passive vibration control further includes a vibration dumping or absorbing spring such as a mechanical spring or an air spring. The active vibration control further includes an actuator such as Lorentz actuators and a motion or vibration detector for detecting the floor vibrations in order to effectively control the actuator. The detectors include acceleration sensors such as servo-type sensors, piezoelectric-type sensors or the like. The reference body isolators 700 are not limited to a particular type or the above described functions to practice certain aspects of the current invention. In the embodiments, the reference body isolators 700 effectively suppress the floor transmission over a wide range of frequencies such as from 10 Hz to 50 Hz. The suppression effectiveness as measured in transmissibility over the above range is less than 0.01 so that the vibrations reaching the isolators 700 are reduced or attenuated by at least 99%. That is, in the embodiment, less than one percent of the floor vibrations reaches the reference body 285 to provide an extremely static and massive reference.

In one embodiment, the reference body subsystem 1500 also includes the lens body 85 that houses an optical assembly 290 for forming an image pattern from the mask onto the wafer. As described above, since the reference body 285 is extremely static due to its mass and the reference body isolators 700, the optical assembly 290 firmly fixed inside the lens body 85 that is attached to the massive reference body 285 are also extremely stable to accurately form an image on the mask without being disturbed by vibrations. As shown in dotted lines, the optical assembly 290 is placed in a cylindrical lens body 85 in the center of the reference body 285, and the light transmitted through the mask or reticle passes through the optical assembly to reach the wafer or substrate.

In addition, the reference body subsystem 1500 includes the position sensor 500. In one embodiment as illustrated in FIG. 3, the reference body 285 are placed on an additional sheet structure 280 that is placed between the reference body 285 and the reference body isolators 700, and the additional sheet structure 280 extends beyond the dimension of the reference body 285 to provides a portion or an area for accommodating the position sensor 500. In another embodiment, the reference body 285 and the additional sheet structure 280 are integrally constructed to provide a portion or an area for accommodating the position sensor 500. In order to detect vibrations in directions of various degrees of freedom, more than one position sensor is used. One embodiment includes six sensors for detecting both x, y, z translational and rotational directions.

For the reference body subsystem 1500, the external disturbances also include air waves such as sounds that do not necessarily travel through the floor. In general, since the static reference body subsystem 1500 is generally located in a certain protected area usually isolated from major sources of external vibrations, the above described other external disturbances are minimized. However, when the minimal disturbances are introduced in the environment, the reference body 285 is so massive that no significant effect is realized for the lithography apparatus by the minimal air disturbances.

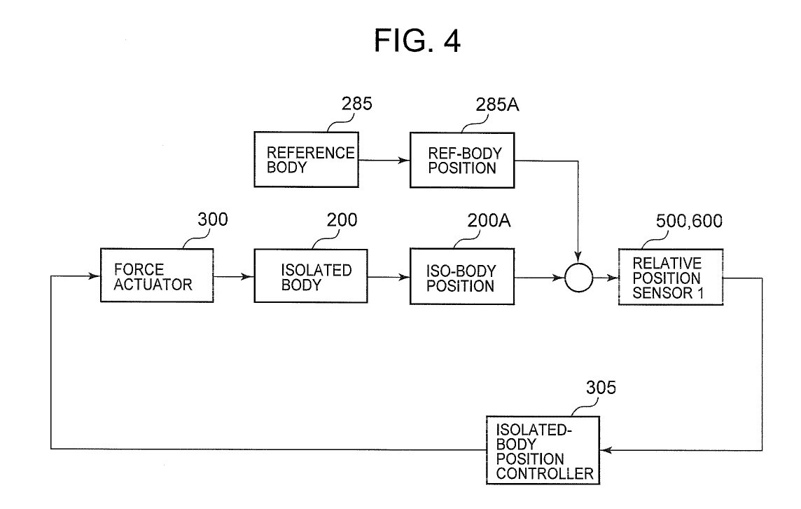

As illustrated in the left hand side of FIG. 3, the isolated body subsystem 1000 of the anti-vibration system includes a support structure 250, a frame 100, an isolated body 200, a force actuator 300, a Piezo actuator unit 400 and a reference body position sensor 600. The isolated body subsystem 1000 provides a substantially stable isolated body 200 by isolating vibration. The physical dimension of the isolated body 200 varies depending upon its application. For example, the isolated body weighs within a range from approximately 200 Kg to approximately 600 Kg for the mask stage application. In one embodiment, although it is not shown in the drawing, the isolated body 200 is designed to isolate vibrations from the mask stage 80, which is located directly on the isolated body 200. In general, the mask stage 80 is known to cause vibrations ranging from 10 Hz to 30 Hz. The use of the isolated body 200 is particularly advantageous to prevent the vibrations mechanically channeled to the support structure 250, which are caused due to a stage reaction force of the mask stage 80, from traveling back to the isolated body 200. In addition, the mask stage 80 also causes the isolated body to pitch due to its internal torque moment, and this type of disturbance is effectively handled by the mechanisms and techniques as later described with respect to FIG. 4.

To accomplish this goal, the position of the isolated body 200 is constantly monitored and continually adjusted relative to that of the static reference body 285 in order to substantially eliminate the effect of vibrations during the image transferring operation in the lithography apparatus. In general, two independent control mechanisms provide the above functions to make the isolated body 200 substantially free from vibrations. One vibration control mechanism involves a first control loop based upon the reference body position sensor 600, the position sensor 500, a force actuator controller 305 and the force actuator 300. The reference body position sensor 600 and the position sensor 500 continuously measure a relative distance between the reference body 285 and the isolated body 200 in real time. Based upon a signal indicative of the relative measured distance, the force actuator controller 305 controls the force actuator 300 to adjust the position of isolated body 200 with respect to the reference body 285. The vibrations on the isolated body 200 are substantially reduced by the physical movement of the isolated body 200 in an opposite direction over the measured change in distance. For example, the force actuator 300 is a Lorentz actuator, and the response characteristic of the force actuator 300 is less than approximately 20 Hz. In order to detect vibrations in various degrees of freedom, at least one pair of the position sensors 500 and 600 is used. One embodiment includes six pairs of the sensors for detecting vibrations respectively in the x, y and z translational and rotational directions for controlling the physical movement in six degrees of freedom. The details for implementing the vibration detection mechanism is known to one of ordinary skill, and one example of such disclosure is seen in U.S. Pat. No. 7,084,956.

Still referring to FIG. 3, the other vibration control mechanism involves a second control loop based upon the Piezo actuator unit 400. The Piezo actuator unit 400 further includes a Piezo actuator 450, a gas or pressure chamber 455, and a Piezo actuator connector 460, a pressure seal 465, a lateral support 470, a ball joint 475, an air-bearing pad 480, an air-bearing layer 485 and a pair of relative position sensors 550, 650. In general, the Piezo actuator unit 400 functions as a gas spring to substantially reduce vibrations in the isolated body 200. In an abstract sense, the Piezo unit 400 also functions as a negative spring by negating the stiffness of the gas spring that has its springy effect equivalently created by the pressured gas enclosure. The gas spring is continuously adjusted by the Piezo actuator 450 as the Piezo actuator 450 continuously deforms itself in response to applied current such that the volume in the gas chamber 455, the Piezo actuator connector 460 and the pressure seal 465 all remain undisturbed or quiet despite the vibrations taking place at the bottom frame 120, the support structure 250, the lateral support 470, the ball joint 475, the air-bearing pad 480 and the air-bearing layer 485. The pressure seal 465 such as diaphragm and the Piezo actuator connector 460 form a portion of the gas chamber 455. As the gas spring is adjusted so that the gas chamber 455, the Piezo actuator connector 460 and the pressure seal 465 become quiet, the position of the isolated body 200 is also controlled to experience the substantially reduced vibrations.

The piezo actuator unit 400 is controlled by the Piezo actuator controller 405 and at least a pair of relative position sensors 550 and 650. The position sensors 550 and 650 are respectively mounted on the bottom and top walls of the gas chamber 455. The top wall of the gas chamber 455 is mounted on the isolated body 200. The position sensors 550 and 650 continuously measure in real time a relative distance between them that reflects the relative displacement of the gas chamber 455 with respect to the isolated body 200. Based upon a signal indicative of the relative measured distance, the Piezo actuator controller 405 controls the position of isolated body 200 with respect to the frame structure 100 by controlling the Piezo actuator 450. The vibrations on the isolated body 200 are substantially reduced by the physical movement of the isolated body 200 in an opposite direction over the measured change in distance. In general, the response characteristic of the Piezo actuator 450 ranges less than approximately 200 Hz or approximately 300 Hz. In particular, the response characteristic of the Piezo actuator 450 ranges from 1-2 Hz to 50-80 Hz, especially from 20 to 30 Hz. In order to detect vibrations in directions of various degrees of freedom, at least one pair of the position sensors 550 and 650 is used.

The Piezo actuator unit 400 includes an additional mechanism for protecting a Piezo actuator during its operation. The protection mechanism includes the ball joint 475, the air-bearing pad 480 and the air-bearing layer 485 to support the Piezo actuator as it expands and constricts. These elements 475, 480 and 485 are located below the Piezo actuator 450 to allow some degree of lateral movement for the Piezo actuator 450 so that they do not impose undesirable lateral constraint during the operation.

The force actuator 300 and the Piezo actuator unit 400 are illustrated to be located on the opposite sides of the isolator body 200 in the schematic diagram in FIG. 3. However, the current invention does not limit as to how these actuators 300 and 400 are mounted on the isolated body 200 or as to how these actuators 300 and 400 are relatively located with each other with respect to the isolated body 200 provided that they each exert the force along the same axis.

In addition, the Piezo actuator unit 400 in the embodiment utilizes a gas spring as illustrated in FIG. 3. However, in another embodiment, the gas spring is replaced by a non-gas spring such as a mechanical spring, an electrostatic spring, a magnetic spring or the like depending upon its application.

The above described anti-vibration system is used to isolate vibrations in the lithography apparatus. That is, the anti-vibration system prevents the vibrations from the floor from traveling to the mask stage 80. Furthermore, the anti-vibration system also prevents the vibrations caused by the reaction force of the mask stage 80 from travelling through the isolated body 200 and the frame structure 100 to the lens body 85. The substantially eliminated vibrations primarily from the floor and secondarily from the mask stage 80 secure a static state in the lens body so that the optical assembly projects a predetermined pattern on the wafer without movement disturbances. Although the embodiment of the anti-vibration system is applied to substantially reduce the vibrations from the floor, the anti-vibration system is optionally applicable to different parts of the lithography apparatus for other sources of internal vibrations such as a wafer stage.

Now referring to FIG. 4, a diagram illustrates the first feedback control loop for the vibration control mechanism according to the current invention. As described above, the first control loop includes at least one pair of the reference body position sensor 600 and the position 500, the force actuator controller or isolated body position controller 305 and the force actuator 300.

As also described, the first control loop involves the reference body 285, whose position 285A is substantially free from movement due to vibrations and force exerted by the force actuator 300. Lastly, the first control loop involves the isolated body 200, whose position 200A is affected by movement due to vibrations and force exerted by the force actuator 300. The reference body position sensor 600 and the position sensor 500 continuously measure a relative distance between the substantially static reference body position 285A and the isolated body position 200A in real time and send the signals indicative of the measured distance to the force actuator controller 305. Based upon the continuously received signal from the sensors 500 and 600, the force actuator controller 305 generates in real time a control signal indicative of an amount and a direction of the movement for controlling the position of isolated body 200 with respect to the frame structure 100 so that the undesirable vibrations with respect to the static reference body 285 are substantially reduced. In other words, the force actuator controller 305 determines the amount of physical movement of the isolated body 200 in an opposite direction over the measured relative distance change. Thus, the force actuator controller 305 continuously sends the generated control signal to the force actuator 300 so as to cancel the measured vibrations. For example, the response characteristic of the force actuator 300 is approximately 20 Hz. The above described feedback loop is continuously repeated in real time to maintain the desirably isolated body position 200A with respect to the reference body position 285A.

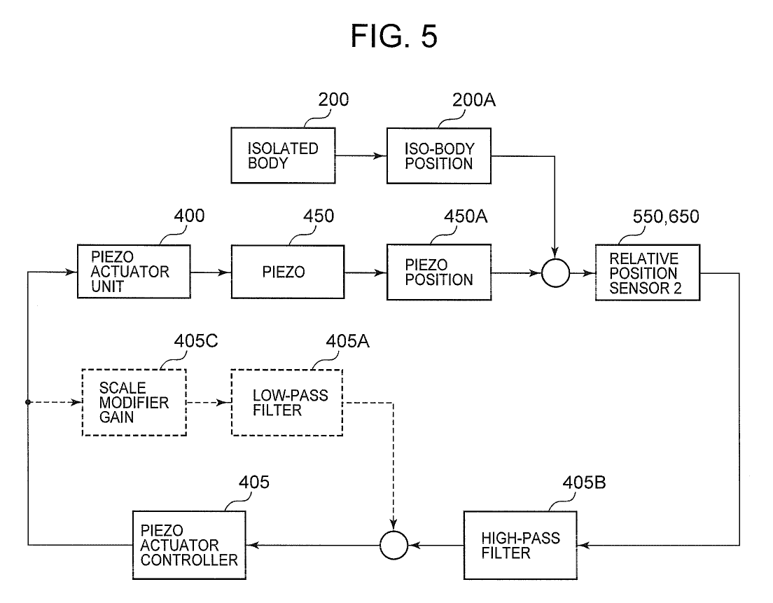

Now referring to FIG. 5, a diagram illustrates the second feed-back control loop for the vibration control mechanism according to the current invention. As described above, the second control loop includes at least one pair of the reference body position sensor 550 and the position sensor 650, the Piezo actuator controller 405 and the Piezo actuator unit 400. As also described, the second control loop involves the isolated body 200, whose position 200A is concurrently controlled by the force actuator 300. Lastly, the second control loop involves the gas spring, and the relative position sensors 550 and 650 in the gas chamber 455 continuously measure the vertical distance indicative of a relative distance between the Piezo position 450A and the isolated body position 200A in real time to send the signals indicative of the measured distance to the Piezo actuator controller 405. Based upon the continuously received signal from the sensors 550 and 650, the Piezo actuator controller 405 generates in real time a control signal indicative of an amount of Piezo deformation such that the gas spring is to remain free of disturbance and the vibration at the frame structure 100 is effectively cut off from traveling to the isolated body 200. In other words, the Piezo actuator controller 405 continuously detects a slightest trend in a gap change that is monitored by the sensors 550 and 650 and immediately commands a Piezo deformation amount such that the trend in the gap change is averted. Thus, the Piezo actuator controller 405 continuously sends the control signal to the Piezo actuator unit 400 and ultimately applies the corresponding current to the Piezo actuator 450 so as to cancel the measured vibrations. In general, the response characteristic of the Piezo actuator 450 is less than approximately from 200 Hz or less than approximately 300 Hz. In particular, the response characteristic of the Piezo actuator 450 ranges from 1-2 Hz to 50-80 Hz, especially from 20 to 30 Hz. The above described feed-back loop is continuously repeated in real time to maintain the desirable isolated body position 200A with respect to the frame 100 and in turn to the reference body position 285A.

Still referring to FIG. 5, the second feed-back loop further includes a high-pass filter 405B for enhancing the performance of the Piezo actuator unit 400. In general, the high-pass filter 405B substantially filters out the signals from the sensors 550 and 650 indicative of low frequency vibrations below a predetermined threshold level. The passed signals indicate vibrations mostly in a predetermined high frequency range so that the Piezo actuator controller 405 determines an amount of physical movement of the isolated body 200 in an opposite direction for cancelling the high frequency vibrations. In other words, since the Piezo actuator unit 400 is designed to effectively reduce vibration in a predetermined high frequency range, the performance of the Piezo actuator unit 400 is enhanced by filtering out the low frequency vibration.

Furthermore, the second feed-back loop optionally includes a scale modifier gain 405C and a low-pass filter 405A for further reducing low frequency vibration. The scale modifier gain 405C receives an output control command signal from the Piezo actuator controller 405 and detects a low frequency component indicative of low frequency vibrations in the Piezo control command signal. Some low frequency vibrations are leaked through or not completely filtered by the high-pass filter 405B. Upon detection of the low frequency component, the scale modifier gain 405C generates a low frequency vibration signal indicative of the same frequency but in a reverse direction to effectively cancel the detected low frequency signal when the detected low frequency vibration and the generated signal are combined. The low-pass filter 405A is connected to the scale modifier gain 405C to ascertain that only the generated low frequency signal is passed back to the Piezo actuator unit 400, which in turn incorporates the reverse low frequency signal into the Piezo control command signal. Ultimately, at the Piezo actuator 450, the still existing low frequency vibrations are now substantially reduced.

The first and second feed-back control loops of FIGS. 4 and 5 are generally independent of each other in one embodiment of the current invention. In other words, the two feed-back loops do not communicate with each other to change the operational condition or characteristics in substantially isolating the isolated body 200 from vibrations. As described above with respect to FIG. 5, the second feed-back control loop is designed to focus on a high frequency range in reducing the vibrations by use of the high-pass filter 405B. However, in another embodiment of the current invention, the first and second feed-back control loops of FIGS. 4 and 5 are optionally interactive with each other or depend upon each other in substantially isolating the isolated body 200 from vibrations. For example, the information from the reference body position sensor 600 and the position sensor 500 as shown in FIG. 4 is fed into the Piezo actuator controller 405 to determine the control command signal for more precisely and effectively controlling the Piezo actuator even when the reference body 285 is not in an absolutely static state.

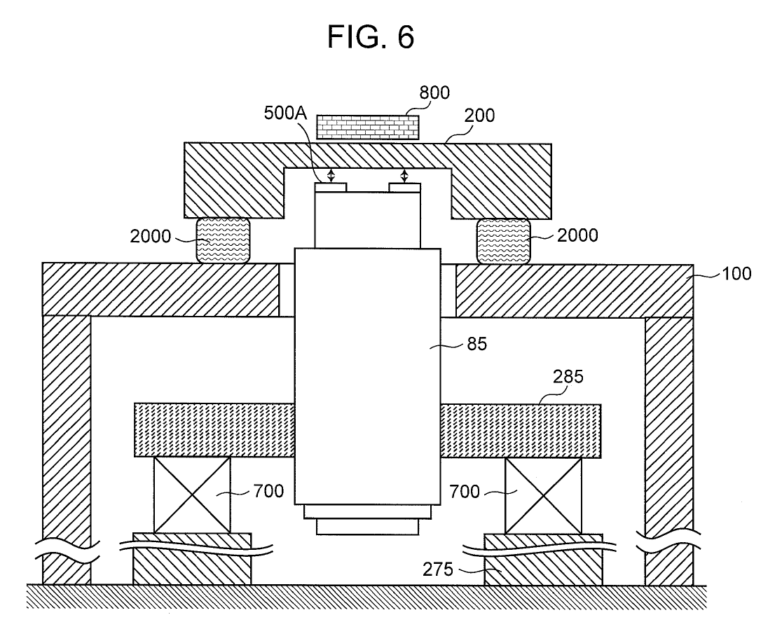

Now referring to FIG. 6, a diagram in a cross-sectional view illustrates a second embodiment of the lithography apparatus according to the current invention. The lithography apparatus includes a light source that is not shown, a mask stage 80 for holding and positioning a mask or a reticle that defines a predetermined pattern, a wafer stage (not shown) for holding and positioning a semiconductor wafer or a substrate to be irradiated according to the predetermined pattern, a lens body 85 located between the two stages for housing an optical assembly that forms an image of the predetermined pattern and a frame structure 100 for ultimately supporting an isolated body 200 via an isolated body subsystem 2000. The lithography apparatus is of various types with its light source using ultraviolet (UV), deep ultraviolet (DUV), extreme ultraviolet (EUV), electron beam or other suitable sources. A reference body 285 holds the lens body 85, which includes a cylindrical portion.

Still referring to FIG. 6, the image formation process is substantially free from vibrations. For example, the lens body 85 is substantially isolated from vibrations that are internally originated from mechanically moving devices such as the mask stage 80 and the wafer stage. The lens body 85 is also substantially free from the vibrations externally originated in the areas such as the floor outside the lithography apparatus. In general, the reference body isolators 700 substantially minimize the vibrations from the wafer stage and the floor while the isolated body subsystem 2000 substantially minimize the vibrations from the mask stage 80. The isolated body subsystem 2000 are located between the isolated body 200 and the frame structure 100, and a set of three isolated body subsystems 2000 is kinematically placed on the frame structure 100 to mount the isolated body 200 so as not to over-constrain the isolated body 200 (only two isolated body subsystems 2000 are shown in FIG. 6).

The reference body subsystem of the anti-vibration system includes a base support structure or base 275, a plurality of reference body isolators 700, a lens body position sensor 500A and a reference body 285. In general, the base 275 is placed directly over the floor such as concrete and is made of rather rigid material such as cast iron. A plurality of the reference body isolators 700 is placed on the base 275 to mount the reference body 285 at a certain predetermined height from the base 275. Although the diagram illustrates only two reference body isolators 700 due to its cross-sectional view, a set of three reference isolators 700 is usually used in a second embodiment.

The reference body subsystem provides an extremely static reference object. To accomplish this goal, the reference body 285 is a huge mass, weighing approximately six metric tons that is at least one half of the total lithographic apparatus weight. The physical dimension of the reference body 285 is in the order of several feet in width, length and height. The reference body 285 has no moving parts to cause internal vibrations and is substantially isolated from external vibrations by the reference body isolators 700. Since the base 275 is placed directly over the floor and made of rather rigid material such as cast iron, it lacks vibration-attenuating function on the vibrations existing on the floor. Although the reference body 285 is placed over the floor, it is supported by a plurality of the reference body isolators 700 to prevent the transmission of the vibrations from the floor via the base 275.

The reference body isolators 700 isolate the vibrations which are externally originated. It should be made certain that no internal vibration source or components are contained within the body that the reference body isolator 700 supports. The externally originated vibrations primarily travel through the base 275 from the floor. In one embodiment, a set of three reference body isolators 700 is kinematically placed on the base 275 to mount the reference body 285 so as not to over-constrain the reference body 285 (only two reference body isolators 700 are shown in FIG. 6). In one embodiment, each of the reference body isolators 700 includes active vibration control elements and passive vibration control elements. The passive vibration control further includes a vibration dumping or absorbing spring such as a mechanical spring or an air spring. The active vibration control further includes an actuator such as Lorentz actuators and a motion or vibration detector for detecting the floor vibrations in order to effectively control the actuator. The detectors include acceleration sensors such as servo-type sensors, piezoelectric-type sensors or the like. The reference body isolators 700 are not limited to a particular type or the above described functions to practice certain aspects of the current invention. In one embodiment, the reference body isolators 700 effectively suppress the floor transmission over a wide range of frequencies such as from 10 Hz to 50 Hz. The suppression effectiveness as measured in transmissibility over the above range is less than 0.01 so that the vibrations reaching the isolators 700 are reduced or attenuated by at least 99%. That is, in the embodiment, less than one percent of the floor vibrations reaches the reference body 285 to provide an extremely static and massive reference.

In the second embodiment, the reference body subsystem 1500 also includes the lens body 85 that houses an optical assembly for forming an image pattern from the mask onto the wafer. As described above, since the reference body 285 is extremely static due to its mass and the reference body isolators 700, the optical lenses firmly fixed inside the lens body 85 are also extremely static to accurately form an image on the mask without being disturbed by vibrations.

In addition, the extremely static reference body subsystem includes the position sensor 500A. In the second embodiment as illustrated in FIG. 6, the reference body 285 supports the lens body 85, and the position sensors 500A are placed on the top of the lens body 85 to measure a distance between the lens body 85 and the isolated body 200. In order to detect vibrations in various degrees of freedom, more than one position sensor 500A is used. The drawing for the second embodiment illustrates only two sensors, but the second embodiment includes at least three pairs for detecting vibrations respectively in the x, y and z directions.

As illustrated in the drawing, the reference body subsystem containing the lens body 85 and the reference body 285 is effectively separated from the isolated body subsystem containing the isolated body 200. Although the base 275 and the frame 100 are mechanically continuous, the lens body 85 and the reference body 285 are vibrationally-isolated with the frame structure 100 so that the vibrations experienced at the frame structure 100 is not traveling to the reference body 285.

For the reference body subsystem 1500, the external disturbances also include air waves such as sounds that do not necessarily travel through the floor. In general, since the static reference body subsystem is generally located in a certain protected area usually isolated from major sources of external vibrations, the above described other external disturbances are minimized. However, when the minimal disturbances are introduced in the environment, the reference body 285 is so massive that no significant effect is realized for the lithography apparatus by the minimal air disturbances.

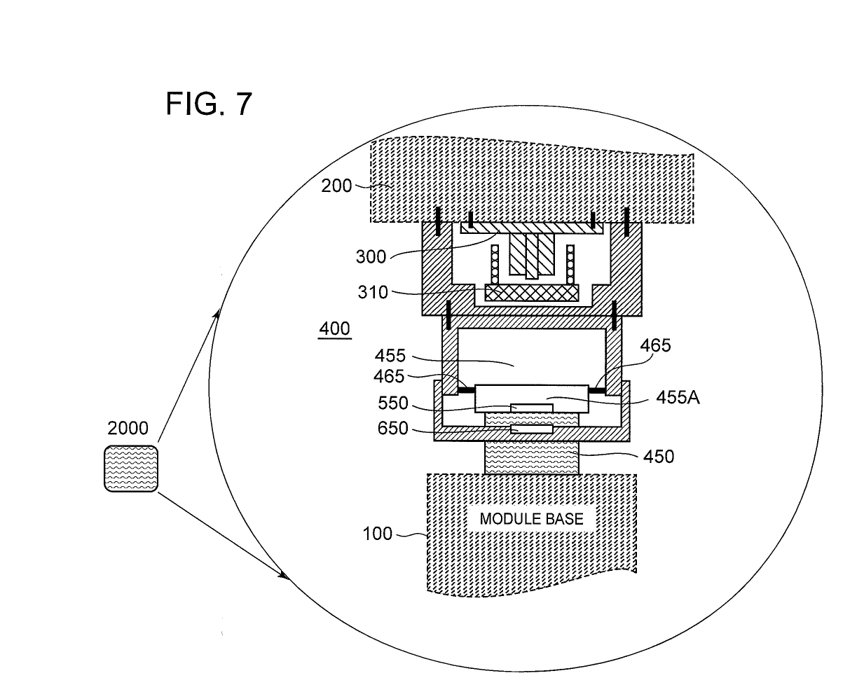

Now referring to FIG. 7, a schematic diagram illustrates the isolated body subsystem 2000 in the second embodiment of the anti-vibration system according to the current invention. The isolated body subsystem 2000 of the anti-vibration system is a mask module isolator and includes the support structure or the frame structure 100, the isolated body 200, a force actuator 300 and a Piezo actuator unit 400. The isolated body subsystem 2000 provides a substantially stable isolated body 200. The physical dimension of the isolated body 200 varies depending upon its application. For example, the isolated body 200 weighs within a range from approximately 200 Kg to approximately 600 Kg for the mask stage application. In the second embodiment, the isolated body 200 is designed to isolate vibrations from a mask stage 80 which is located directly on the isolated body 200. In general, the mask stage 80 is known to cause vibrations ranging from approximately 10 Hz to approximately 30 Hz. The use of the isolated body 200 is particularly advantageous to prevent the vibrations caused by the mask stage 80 from traveling to the support structure 100.

To accomplish this goal, the position of the isolated body 200 is constantly monitored and continually adjusted relative to that of the lens body 85 in order to substantially eliminate the effect of vibrations during the image transferring operation in the lithography apparatus. In general, two independent active control mechanisms provide the above functions to make the isolated body 200 substantially free from vibrations. One vibration control mechanism involves a first control loop based upon the lens body position sensor 500A of FIG. 6, the force actuator controller (not shown) and the force actuator 300. The lens body position sensors 500A continuously measure a relative distance between the substantially static lens body 85 and the isolated body 200 in real time as illustrated in FIG. 6. In order to detect vibrations in various degrees of freedom, more than one position sensor 500A is used. One embodiment includes six pairs of the sensors for detecting vibrations respectively in the x, y and z translational and rotational directions for controlling the physical movement in six degrees of freedom. The details for implementing the vibration detection mechanism is known to one of ordinary skill, and one example of such disclosure is seen in U.S. Pat. No. 7,084,956.

Based upon a signal indicative of the relative measured distance, the force actuator controller 305 controls the force actuator 300 in order to adjust the position of isolated body 200 with respect to the lens body 85 and the reference body 285. The vibrations in a predetermined low frequency range on the isolated body 200 are substantially reduced by the physical movement of the isolated body 200 in an opposite direction over the measured change in distance. For example, the force actuator 300 is a Lorentz actuator, and the response characteristic of the force actuator 300 is less than approximately 20 Hz. The force actuator 300 further includes an actuator reaction force channeling structure 310, which absorbs the reaction force and channels it to the frame structure 100 or the floor.

Still referring to FIG. 7, the other vibration control mechanism involves a second control loop based upon the Piezo actuator unit 400. The Piezo actuator unit 400 further includes a Piezo actuator 450, a gas or pressure chamber 455, an air spring piston 455A, a pressure seal 465 and a pair of relative position sensors 550, 650. The top wall of the gas chamber 455 is connected to the bottom of the isolated body 200. Thus, the force actuator 300 and the Piezo actuator unit 400 are placed on top of each other in the second embodiment. In general, the Piezo actuator unit 400 functions as a gas spring to substantially reduce vibrations in the isolated body 200. In an abstract sense, the Piezo unit 400 also functions as a negative spring by negating the stiffness of the gas spring that has its springy effect equivalently created by the pressured gas enclosure. The gas spring is continuously adjusted by the Piezo actuator 450 as the Piezo actuator 450 continuously deforms itself in response to applied current such that the volume in the gas chamber 455 and the pressure seal 465 all remain undisturbed or quiet despite the vibrations taking place at the frame structure 100, the support structure 275, the air spring piston 455A and the pressure seal 465. The pressure seal 465 such as diaphragm forms a portion of the gas chamber 455. As the gas spring is adjusted so that the gas chamber 455 and the pressure seal 465 become quiet, the position of the isolated body 200 is also controlled to experience the substantially reduced vibrations.

The piezo actuator unit 400 is controlled by the Piezo actuator controller 405 (not shown) based upon a signal from a pair of relative position sensors 550 and 650. The position sensors 550 and 650 are respectively mounted on the air spring piston 455A and the bottom frame of the gas chamber 455. The position sensors 550 and 650 continuously measure in real time a relative distance between them. Based upon a signal indicative of the relative measured distance, the Piezo actuator controller 405 controls the Piezo actuator 450 to adjust such that the distance between the position sensors 550 and 650 is always kept constant. The vibrations transmitted to the isolated body 200 are substantially reduced by the physical movement of the Piezo material 450 in an opposite direction over the measured change in distance. For example, the response characteristic of the Piezo actuator 450 ranges less than approximately 200 Hz or approximately 300 Hz. In particular, the response characteristic of the Piezo actuator 450 ranges from 1-2 Hz to 50-80 Hz, especially from 20 to 30 Hz. Only one pair of the position sensors 550 and 650 is used for each of the Piezo unit.

The Piezo actuator unit 400 includes an additional mechanism for protecting a Piezo actuator 450 during its operation. Although it is not shown in the drawing, the protection mechanism protects the Piezo actuator as it expands and constricts. The protection mechanism is placed below the Piezo actuator 450 to allow some degree of lateral movement for the Piezo actuator 450 so that the surrounding structures do not impose undesirable lateral constraint during the operation.

The force actuator 300 and the Piezo actuator unit 400 are illustrated on the same side of the isolator body 200 in the schematic diagram in FIG. 7. However, the current invention does not limit as to how these actuators 300 and 400 are mounted on the isolated body 200 or as to how these actuators 300 and 400 are relatively located with each other with respect to the isolated body 200, provided that they each exert the force along the same axis.

In addition, the Piezo actuator unit 400 in the second embodiment utilizes a gas spring as illustrated in FIG. 7. However, in alternative embodiments, the gas spring is replaced by a non-gas springs such as a mechanical spring, an electrostatic spring, a magnetic spring or the like depending upon its application.

The above described anti-vibration system is used to isolate vibrations in the lithography apparatus. That is, the anti-vibration system is located near the isolated 200 body so that the vibrations caused by the floor are prevented from traveling through the isolated body and the frame structure 100 to support the mask stage 80. Furthermore, the anti-vibration system is also located near the isolated body 200 where the mask stage 80 is mounted so that the vibrations caused by the reaction force of the mask stage 80 are prevented from traveling through the isolated body 200 and the frame structure 100 to the lens body 85. Thus, the lack of vibrations primarily from the floor and secondarily from the mask stage 80 secures a static state in the lens body 85 so that the optical assembly 290 projects a predetermined pattern on the wafer without disturbance. Although the embodiment of the anti-vibration control system is applied to substantially reduce the vibrations from the floor, the anti-vibration system is optionally applicable to different parts of the lithography apparatus for other sources of internal vibrations such as a wafer stage.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A vibration isolation apparatus, comprising:
a reference body;
an isolated body, which is supported by a frame structure;
a first sensor located on at least one of the reference body and the isolated body for measuring a distance between the reference body and the isolated body;
a second sensor located on at least one of the isolated body and the frame structure for measuring a distance between the isolated body and the frame structure;
a first actuator provided between the frame structure and the isolated body exerting a first force in response to an output of the first sensor; and
a second actuator provided between the frame structure and the isolated body exerting a second force in response to an output of the second sensor.

2. The vibration isolation apparatus according to claim 1 wherein the first actuator and the second actuator are arranged in dynamically parallel to each other with respect to the isolated body.

3. The vibration isolation apparatus according to claim 1 wherein the first actuator and the second actuator are arranged coaxially.

4. The vibration isolation apparatus according to claim 1 wherein the reference body is isolated from the frame structure.

5. The vibration isolation apparatus according to claim 1 further comprising:
a spring member provided between the isolated body and the frame structure in series to the second actuator.

6. The vibration isolation apparatus according to claim 1 wherein said second actuator is a Piezo actuator having a response frequency.

7. The vibration isolation apparatus according to claim 6 wherein the Piezo actuator deforms itself to apply force to an air spring connecting to the isolated body.

8. The vibration isolation apparatus according to claim 6 wherein the response frequency is less than approximately 300 Hz.

9. The vibration isolation apparatus according to claim 8 wherein the response frequency ranges from approximately 20 Hz to 30 Hz.

10. The vibration isolation apparatus according to claim 1 further comprising:
a high-pass filter connected to the second sensor for substantially filtering out low-frequency vibrations to generate a high-frequency vibration signal for controlling the second actuator in a predetermined high-frequency range.

11. The vibration isolation apparatus according to claim 1 further comprising:
a low-pass filter connected to the second sensor for passing the reverse low-frequency vibration signal to cancel still existing low-frequency vibrations that leaked through the high-pass filter.

12. A lithography apparatus, comprising:
a lens body including an optical assembly and a reference body;
an isolated body located near said lens body;
a stage located on said isolated body; and
a active-control vibration isolation device located between said reference body and said stage for substantially preventing the vibrations from a floor from traveling to said stage and the vibrations caused by said stage from travelling to said lens body, said active-control vibration isolation device having a first active control unit and a second active control unit for substantially reducing vibrations respectively in a first frequency range and a second frequency range.

13. The lithography apparatus according to claim 12 wherein said first active control unit further comprises a force actuator connected to said isolated body for actively exerting a first force in response to vibrations in a manner to reduce the vibrations.

14. The lithography apparatus according to claim 13 wherein said force actuator exerts the first force in less than approximately 20 Hz.

15. The lithography apparatus according to claim 12 wherein said second active control unit further comprises a spring having a top and a bottom and a Piezo actuator connected to said air spring for actively exerting a second force in response to the vibrations in a manner to reduce the vibrations.

16. The lithography apparatus according to claim 15 wherein said Piezo actuator exerts the second force in less than approximately 300 Hz.

17. The lithography apparatus according to claim 12 wherein said first active control unit and said second active control unit respectively exert the first force and the second force along the same axis.

18. The lithography apparatus according to claim 13 further comprising:
a first relative distance sensor located on said lens body for measuring a distance between said lens body and said isolated body to generate a first distance signal; and
a first actuator controller connected to said first relative distance sensor and said force actuator for controlling the first force based upon the first distance signal.

19. The lithography apparatus according to claim 15 further comprising:
a frame structure for supporting said isolated body;
a second relative distance sensor located near said spring for measuring a distance between said top and said bottom of said spring to generate a second distance signal; and
a second actuator controller connected to said second relative distance sensor and said Piezo actuator for controlling the second force based upon the second distance signal.

20. The lithography apparatus according to claim 19 further comprising:
a high-pass filter connected to said second relative distance sensor for substantially filtering out low-frequency vibrations to generate a high-frequency vibration signal, said second actuator controller generating a high-frequency control command signal based upon the high-frequency vibration signal to control said second actuator in a predetermined high-frequency range.

21. The lithography apparatus according to claim 21 further comprising:
a scale modifier gain connected to said second actuator controller for receiving the high-frequency control command signal for detecting a low-frequency component in the high-frequency control command signal and generating a reverse low-frequency vibration signal; and
a low-pass filter connected to said scale modifier gain and said second actuator controller for passing the reverse low-frequency vibration signal to said second actuator controller in attempt to cancel still existing low-frequency vibration that leaked through said high-pass filter.

22. A method of effectively isolating vibrations in a lithography apparatus, comprising the steps of:
isolating a static reference body from externally caused vibrations via reference body isolators;
measuring vibrations in a first distance in a first frequency range in the lithography apparatus with respect to the static reference body to generate a first measured vibration signal;
actively controlling the vibrations in the first frequency range based upon the first measured vibration signal;
further measuring vibrations in a second distance in a second frequency range in the lithography apparatus with respect to the frame structure to generate a second measured vibration signal; and
further actively controlling the vibrations in the second frequency range based upon the second measured vibration signal.

23. The method of effectively isolating vibrations in a lithography apparatus according to claim 22 wherein said actively controlling step is performed by a Lorentz actuator in the first frequency range within approximately 20 HZ.

24. The method of effectively isolating vibrations in a lithography apparatus according to claim 22 wherein said further actively controlling step is performed by a Piezo actuator in the second frequency range within approximately 300 HZ.

25. The method of effectively isolating vibrations in a lithography apparatus according to claim 22 wherein said actively controlling step and said further actively controlling step are performed repeatedly and simultaneously.

26. The method of effectively isolating vibrations in a lithography apparatus according to claim 22 wherein said actively controlling step and said further actively controlling step are performed independently.

27. A method of effectively isolating vibrations in a lithography apparatus, comprising the steps of:
isolating a static reference body from externally caused vibrations via reference body isolators;
measuring vibrations in a first distance in a first frequency range of less than approximately 20 Hz with respect to the static reference body to generate a first measured vibration signal;
actively controlling the vibrations in the first frequency range of based upon the first measured vibration signal;
further measuring vibrations in a second distance in a second frequency range of less than approximately 300 HZ with respect to the frame structure to generate a second measured vibration signal; and
further actively controlling the vibrations in the second frequency range based upon the second measured vibration signal.
